(19) United States
(12) Patent Application Publication
(10) Pub. No.: US 2025/0199867 A1
(43) Pub. Date: Jun. 19, 2025

(54) DATA PROCESSING APPARATUS, METHOD, AND PROGRAM

(71) Applicant: NIPPON TELEGRAPH AND TELEPHONE CORPORATION, Tokyo (JP)

(72) Inventors: Chao WU, Musashino-shi (JP); Shingo HORIUCHI, Musashino-shi (JP); Hiroaki KIKUSHIMA, Musashino-shi (JP); Nobukazu FUKUDA, Musashino-shi (JP)

(73) Assignee: NIPPON TELEGRAPH AND TELEPHONE CORPORATION, Tokyo (JP)

(21) Appl. No.: 18/843,412

(22) PCT Filed: Mar. 11, 2022
(86) PCT No.: PCT/JP2022/011065

§ 371 Date: Sep. 3, 2024

(51) Int. Cl. G06F 9/50

(52) U.S. Cl. CPC G06F 9/5033

(57) ABSTRACT

According to one embodiment, a data processing apparatus includes an extraction unit that extracts a candidate for a resource used to provide a service and a candidate for a parameter used to control the resource, from a file in which a content of provision of the service is described, and a designation unit that receives a designation of a resource and a parameter to be used to provide the service among resources and parameters extracted by the extraction unit.

### TECHNICAL FIELD

Embodiments of the present invention relate to a data processing apparatus, a method, and a program.

### BACKGROUND ART

Conventionally, as a method of resource control based on an intent (intent or purpose of a user (who may be referred to as a customer)) such as a service quality requirement related to a network service, an application service, or the like, a so-called inquiry base method in which an inquiry or the like is made to a developer or an administrator of an application program (which may be referred to below as an application or the like), a network, a server, or the like (which may be referred to below as an application or the like), that is, through manual intervention, an adjustable resource or parameter in the application or the like or a range of an adjustable value of the parameter is grasped has been adopted.

### CITATION LIST

### Non Patent Literature

Non Patent Literature 1: Wu et al., “Intent-driven cloud resource design framework to meet cloud performance requirements and its application to a cloud-sensor system”, Journal of Cloud Computing: Advances, Systems and Applications (2021)

### SUMMARY OF INVENTION

### Technical Problem

However, in the manual intervention technique as described above, a large human cost is generated. In addition, there is a risk of a resource or a parameter unnoticed by a user, an administrator, and a developer being leaked., and there is a problem in responding to a change in a controllable resource or parameter due to a change in a service provision environment, a specification, or the like.

The present invention has been made in view of the above circumstances, and an object thereof is to provide a data processing apparatus, a method, and a program capable of appropriately controlling a resource based on an intent.

### Solution to Problem

According to one aspect of the present invention, a data processing apparatus includes an extraction unit that extracts a candidate for a resource used to provide a service and a candidate for a parameter used to control the resource, from a file in which a content of provision of the service is described, and a designation unit that receives a designation of a resource and a parameter to be used to provide the service among resources and parameters extracted by the extraction unit.

According to another aspect of the present invention, there is provided a data processing method performed by a data processing apparatus, the method includes extracting, by an extraction unit of the data processing apparatus, a candidate for a resource used to provide a service and a candidate for a parameter used to control the resource from a file in which a content of provision of the service is described, and receiving, by a designation unit of the data processing apparatus, a designation of a resource and a parameter to be used to provide the service among extracted resources and parameters.

### Advantageous Effects of Invention

According to the present invention, it is possible to appropriately control a resource based on an intent.

### BRIEF DESCRIPTION OF DRAWINGS

FIG. 1 is a diagram illustrating an application example of a data processing apparatus according to one embodiment of the present invention.

FIG. 2 is a diagram illustrating an example of a management target of an intent-based resource management unit.

FIG. 3 is a diagram illustrating another application example of the data processing apparatus according to the one embodiment of the present invention.

FIG. 4 is a diagram illustrating an example of an operation by a parameter extraction unit.

FIG. 5 is a diagram illustrating an example of an operation by a parameter variation detection unit.

FIG. 6 is a flowchart illustrating an example of a procedure of processing by the data processing apparatus according to the one embodiment of the present invention.

FIG. 7 is a diagram illustrating a specific example of parameter extraction.

FIG. 8 is a diagram illustrating a specific example of parameter variation detection.

FIG. 9 is a block diagram illustrating an example of a hardware configuration of the data processing apparatus according to the one embodiment of the present invention.

### DESCRIPTION OF EMBODIMENTS

Hereinafter, one embodiment according to the present invention will be described with reference to the drawings.

In this embodiment, as a first stage (initial stage), a candidate for a resource that can be set for intent-based resource control or a candidate for a parameter used to control the resource, the candidates being used to provide a service, is extracted from a file in which the content of provision of the service is described, by using a method such as a rule or natural language. The file is a management file related to control of an application, a network, a server, or the like, for example, a contract document, a specification document, a configuration (config) file, or the like (which may be referred to below as a configuration or the like)

In addition, in the present embodiment, as a second stage (operation stage), a change in the above-described configuration or the like related to the application, the network, the server, or the like is periodically checked, and a variation of a new resource or parameter caused by a change in a service provision environment, a specification, or a contract is extracted as a candidate for a new settable resource or parameter. Furthermore, a process related to the first stage may be performed again as necessary.

The above candidate may be presented to a user, a developer, or an administrator, and thus addition, modification, or validation may be performed on the candidate by the administrator.

In this embodiment, the candidate for the new settable resource or parameter is automatically extracted, and the extracted result is validated by the administrator, so that the settable parameter and the like can be comprehensively extracted as compared with a conventional manual inquiry base method. Therefore, it is possible to reduce human cost, and to greatly reduce a time required for extraction, so that it is possible to appropriately introduce intent-based control. In addition, it is also possible to prevent control related to an unexpected parameter.

In addition, in the present embodiment, a new settable resource or parameter is extracted based on a change in the configuration or the like as described above. Thus, it is possible to quickly and flexibly respond to a change in a service provision environment, a specification, or the like, or a change in a use environment of a user after the introduction of the intent-based control.

For simplicity, the description will be made on the assumption that only a parameter is an extraction target.

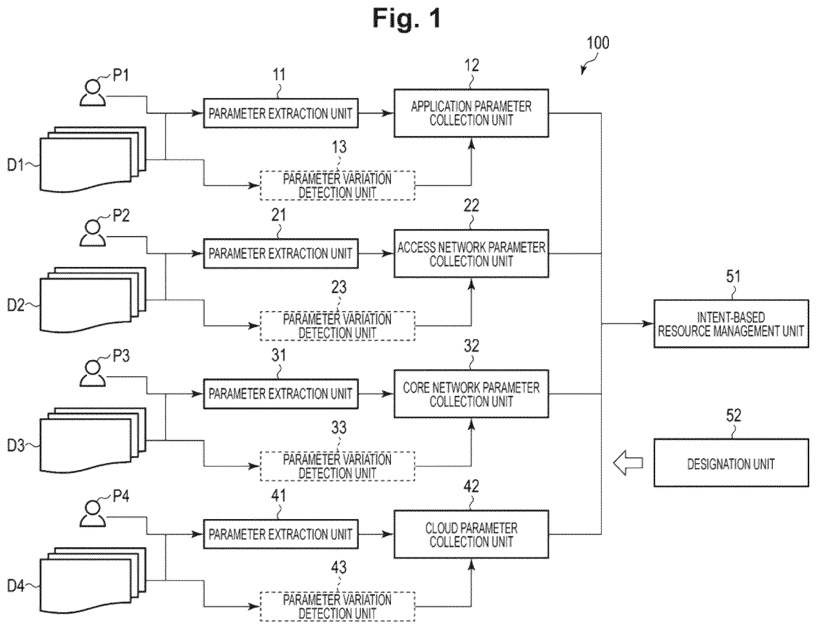

FIG. 1 is a diagram illustrating an application example of a data processing apparatus according to the one embodiment of the present invention.

As illustrated in FIG. 1, a resource management apparatus 100 that is a data processing apparatus according to the one embodiment of the present invention includes a parameter extraction unit 11, an application parameter collection unit (application parameter collection unit) 12, and a parameter variation detection unit 13 as a configuration related to an application.

The resource management apparatus 100 includes a parameter extraction unit 21, an access network parameter collection unit 22, and a parameter variation detection unit 23 as a configuration related to an access network.

The resource management apparatus 100 includes a parameter extraction unit 31, a core network parameter collection unit 32, and a parameter variation detection unit 33 as a configuration related to a core network.

The resource management apparatus 100 includes a parameter extraction unit 41, a cloud parameter collection unit 42, and a parameter variation detection unit 43 as a configuration related to a server.

The parameter extraction units 11, 21, 31, and 41 may be referred to as each parameter extraction unit below. The application parameter collection unit 12, the access network parameter collection unit 22, the core network parameter collection unit 32, and the cloud parameter collection unit 42 may be referred to as each parameter collection unit below. The parameter variation detection units 13, 23, 33, and 43 may be referred to as each parameter variation detection unit below.

The resource management apparatus 100 includes an intent-based resource management unit 51 at a subsequent stage of each parameter collection unit described above, and includes a designation unit 52 that receives an input operation related to a designation of a parameter and designates a parameter in response to the input operation.

Here, as a configuration used in the first stage, the configuration other than each parameter variation detection unit will be described.

In addition, FIG. 1 illustrates the configuration for performing parameter extraction, collection, and the like related to four types of resources. However, for example, only a configuration for performing parameter extraction, collection, and the like related to one to three types of resources to be controlled may be provided, or a configuration for performing parameter extraction, collection, and the like related to five or more types of resources to be controlled may be provided.

In addition, when a configuration for performing parameter extraction, collection, and the like related to a plurality of types of resources is provided, these configurations may operate in series or in parallel.

The parameter extraction unit 11 extracts a candidate for a new settable parameter for an application from a management file D1 that may include an application specification document, a system configuration, a client configuration, or the like. The extracted candidate is transferred to the intent-based resource management unit 51 via the application parameter collection unit 12. Note that an application developer or the like (reference sign p1 in FIG. 1) may directly set the parameter by an input operation on the resource management apparatus 100.

The parameter extraction unit 21 extracts a candidate for a new settable parameter for the access network from a management file D2 including an access network specification document, a contract document, the system configuration, or the like. The extracted candidate is transferred to the intent-based resource management unit 51 via the access network parameter collection unit 22. Note that an access network administrator or the like (reference sign p2 in FIG. 1) may directly set the parameter by an input operation on the resource management apparatus 100.

The parameter extraction unit 31 extracts a candidate for a new settable parameter for the core network from a management file D3 Including a core network specification document, the contract document, the system configuration, or the like. The extracted candidate is transferred to the intent-based resource management unit 51 via the core network parameter collection unit 32. Note that a core network administrator or the like (reference sign p3 in FIG. 1) may directly set the parameter by an input operation.

The parameter extraction unit 41 extracts a candidate for a new settable parameter for the cloud server from a management file D4 including a cloud server specification document, the contract document, the system configuration, or the like. The extracted candidate is transferred to the intent-based resource management unit 51 via the cloud parameter collection unit 42. Note that a cloud administrator or the like (reference sign p4 in FIG. 1) may directly set the parameter by an input operation on the resource management apparatus 100. The management files D1 to D4 may be referred to as each management file below.

In the first stage in the present embodiment, when the intent-based resource management is first introduced, new settable parameters are comprehensively extracted from the management files by the various parameter extraction units.

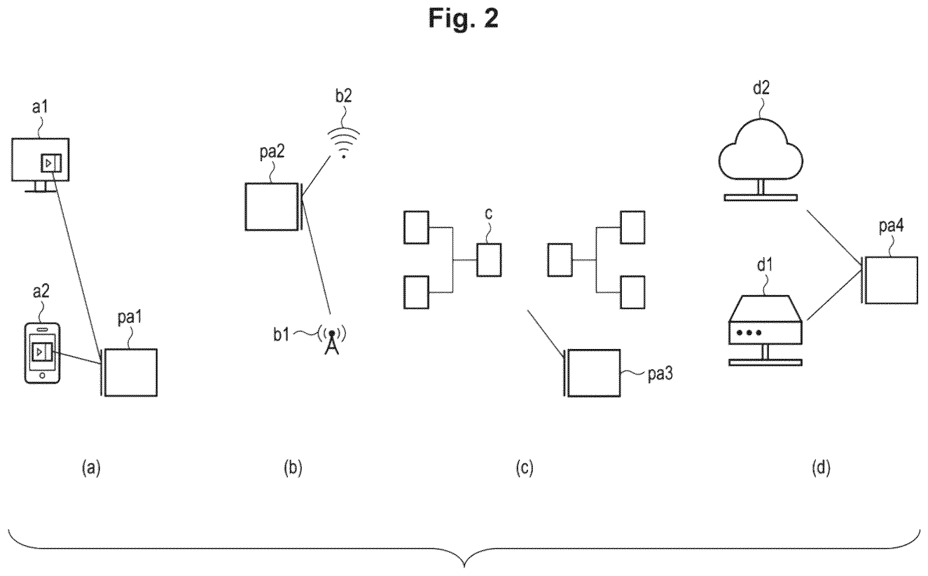

FIG. 2 is a diagram illustrating an example of a management target of the intent-based resource management unit.

Next, types of a resource and a parameter for controlling the resource according to an intent will be described.

The intent-based resource management unit si recognizes a resource or a parameter indicated in the following (1) to (4) and appropriately controls the resource so that an intent such as the service quality requirement is satisfied.
(1) A parameter (reference sign pa1 in FIG. 2) that is controllable inside an application installed on a personal computer (reference sign a1 in FIG. 2) or a portable terminal (reference sign a2 in FIG. 2)
(2) A parameter (reference sign pa2 in FIG. 2) that is controllable with an access network resource (reference signs b1 and b2 in FIG. 2)
(3) A parameter (reference sign pa3 in FIG. 2) that is controllable with a core network resource (reference sign c in FIG. 2)
(4) A resource and a controllable parameter (reference sign pa4 in FIG. 2) of a stationary server (reference sign d1 in FIG. 2) or a cloud server (reference sign d2 in FIG. 2) that processes a load

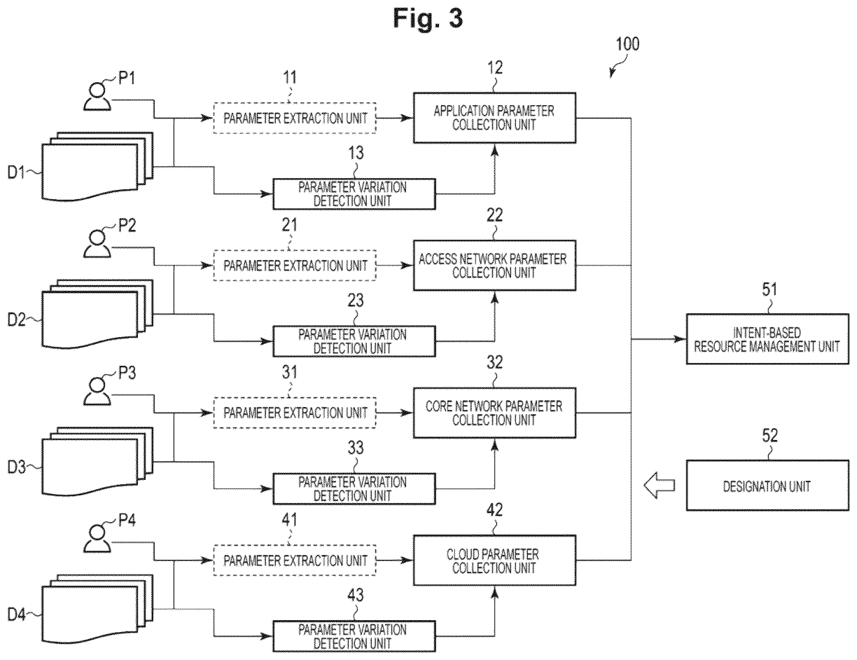

FIG. 3 is a diagram illustrating another application example of the data processing apparatus according to the one embodiment of the present invention.

Here, as a configuration used in the second stage, various parameter variation detection units, that is, the parameter variation detection units 13, 23, 33, and 43 will be described.

In the present embodiment, it is assumed that the various parameter extraction units repeatedly perform extraction at periodic timings, and the results collected at the respective timings are collected by the various parameter variation detection units and accumulated in internal memories of the various parameter variation detection units.

During the operation, there is a possibility that a parameter that does not exist at the initial stage newly appears due to a change in a service provision environment, a specification, or a contract. However, as in the first stage described above, in the method in which the management file such as the specification document or the contract document is read again by the various parameter extraction units and the type of the settable parameter or the like is extracted again, the extraction results overlap each other, and the time and cost are wasted.

Therefore, in the present embodiment, as the second stage, the various parameter variation detection units periodically check variations in the content of the management file such as the configuration in time series, and detect a parameter newly generated in the configuration or the like in the management file, so that it is possible to extract only the parameter after the variation.

Specifically, the parameter variation detection unit 13 periodically checks the variation in the content of the management file D1 including the application specification document, the contract document, the system configuration, and the client configuration, in time series. When the variation in the management file, for example, addition of a new parameter, change of a parameter value (for example, a numerical value or an identifier (ID)), deletion of a parameter, or the like is performed, the parameter variation detection unit 13 extracts the content of the variation and transfers the content to the application parameter collection unit 12. The application parameter collection unit 12 changes the collection result in the first stage according to the transferred content.

The parameter variation detection unit 23 periodically checks the variation in the content of the management file D2 such as the access network specification document in time series. When the variation in the management file has occurred, the parameter variation detection unit 23 extracts the content of the variation, and transfers the content of the variation to the access network parameter collection unit 22. The access network parameter collection unit 22 changes the collection result in the first stage according to the transferred content.

The parameter variation detection unit 33 periodically checks the variation in the content of the management file D3 such as the core network specification document in time series. When the variation in the management file has occurred, the parameter variation detection unit 33 extracts the content of the variation, and transfers the content of the variation to the core network parameter collection unit 32. The core network parameter collection unit 32 changes the collection result in the first stage according to the transferred content.

The parameter variation detection unit 43 periodically checks the variation in the content of the management file D4 such as the server service specification document in time series. When the variation in the management file has occurred, the parameter variation detection unit 43 extracts the content of the variation, and transfers the content of the variation to the cloud parameter collection unit 42. The cloud parameter collection unit 42 changes the collection result in the first stage according to the transferred content.

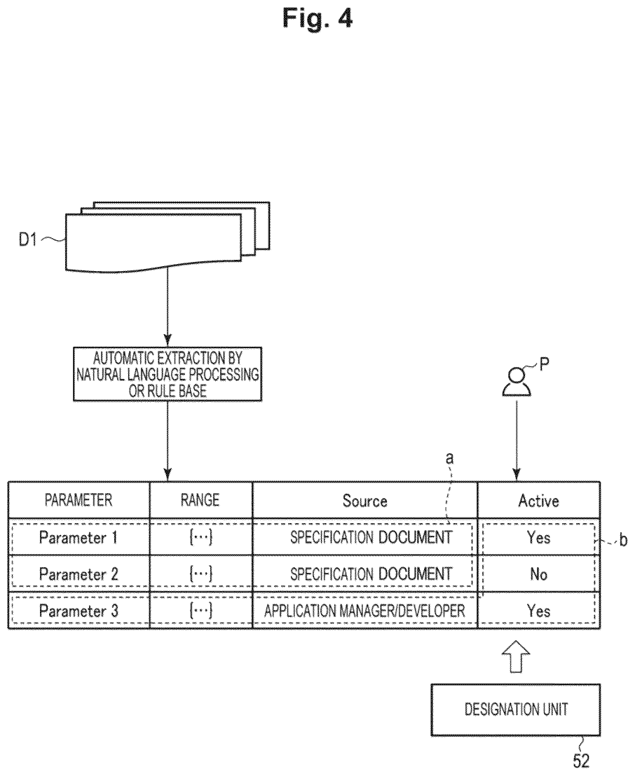

Next, an operation of the parameter extraction unit in the first stage will be described. FIG. 4 is a diagram illustrating an example of the operation by the parameter extraction unit. Here, the parameter extraction unit 11 will be described as an example.

The parameter extraction unit 11 automatically extracts a candidate (“Parameter 1” and “Parameter 2” in FIG. 4) for a type of new settable parameter and a candidate for a range of a possible value for the parameter (may be referred to as the type and the range of the value of the parameter) from the management file D1 including the application specification document, the contract document, the system configuration, and the client configuration, as a candidate for a parameter to be controlled by the intent-based resource management unit 51 with a method such as natural language processing or rule base.

The parameter extraction unit 11 sets an initial value of an Active flag (“Active” in FIG. 4) to “No” in association with information of an extraction source (“specification document” in FIG. 4) of the candidate in the management file D1. The Active flag is a flag indicating whether or not to validate the candidate, that is, whether or not to set the type and the range of the value of the parameter to be controlled by the intent-based resource management unit 51. The parameter extraction unit 11 transfers the result of this setting to the application parameter collection unit 12 as information on the candidate for the parameter. The Active flag may be referred to as a validation flag.

The application parameter collection unit 12 accumulates the information transferred from the parameter extraction unit 11 in an internal memory, and presents the information to an application administrator/developer (may be referred to as an operator), a user, or the like (reference sign P in FIG. 4) by screen display or the like. The information on the candidate for the parameter may be presented to the user, for example.

The application administrator/developer or the like who has received this presentation determines a parameter to be controlled by the intent-based resource management unit 51, for example, a parameter type “Parameter 1” in FIG. 4 from the presented parameter candidate information. Then, the application administrator/developer or the like performs an input operation to the resource management apparatus 100 to designate the parameter of this type as the parameter to be controlled. The designation unit 52 receives this input operation and sets the Active flag associated with the same record as a record (each row in FIG. 4) of the parameter designated by the input operation to “Yes”.

In addition to the type and the range of the value of the parameter that has been automatically extracted, the application administrator/developer or the like can register a desired parameter (“Parameter 3” in FIG. 4) and the range of the value of the parameter to be controlled by the intent-based resource management unit 51, by an input operation to the resource management apparatus 100. At this time, an initial value of the Active flag in the same record is set to “Yes” by the designation unit 52.

An item surrounded by the reference sign a in FIG. 4 is an item set through automatic extraction by the parameter extraction unit 11. An item surrounded by the reference sign b in FIG. 4 is an item set by the designation unit 52 in response to an input operation by the application administrator/developer or the like.

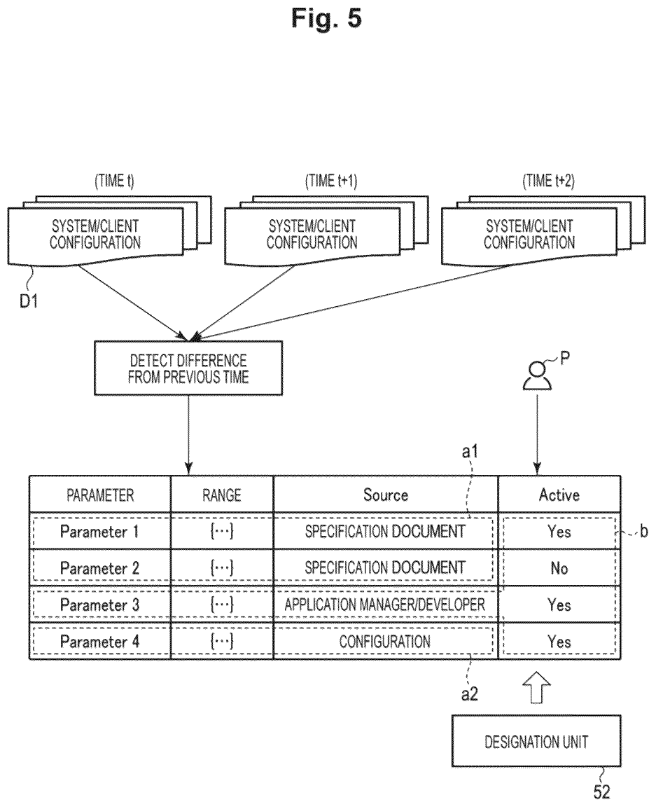

Next, an operation of the parameter variation detection unit in the second stage will be described. FIG. 5 is a diagram illustrating an example of the operation by the parameter variation detection unit. Here, the parameter variation detection unit 13 will be described as an example.

The parameter variation detection unit 13 periodically reads the management file D1 including the application specification document, the contract document, the system configuration, and the client configuration, and detects a difference between the content of the read management file D1 and the content of the management file D1 read at a timing (for example, a time t in FIG. 5) before a predetermined time from the current time (for example, a time t+1 in FIG. 5).

For example, when the content of the configuration in the management file D1 changes during a period from the time t+1 to a time t+2, for example, when a parameter of a new type is found, the parameter variation detection unit 13 transfers the type (for example, “Parameter 4” in FIG. 5) and the range of the value of the new parameter, which have been detected as the difference, to the application parameter collection unit 12 as the candidates (parameter candidates) for the type and the range of the value Of the new parameter to be controlled by the intent-based resource management unit 51.

The application parameter collection unit 12 sets an initial value of the Active flag (“No” in the row of “Parameter 4” in FIG. 5) to the information transferred from the parameter extraction unit 11, and presents the information as information on a new candidate for the parameter to the application administrator/developer or the like (reference sign P in FIG. 5) by screen display or the like. The information on the candidate for the new parameter may be presented to the user, for example.

When appropriately determining the presented candidate as the parameter to be controlled by the intent-based resource management unit 51, the application administrator/developer or the like that has received the presentation performs an input operation to the resource management apparatus 100 to designate this type of parameter as the parameter to be controlled. The designation unit 52 receives this input operation and sets the Active flag associated with the same record as a record of the designated parameter to “Yes”.

An item surrounded by the reference sign a1 in FIG. 5 is an item set through automatic extraction by the parameter extraction unit 11. An item surrounded by the reference sign a2 in FIG. 5 is an item se, through automatic detection by the parameter variation detection unit 13. An item surrounded by the reference sign b in FIG. 5 is an item set by the designation unit 52 in response to an input operation by the application administrator/developer or the like.

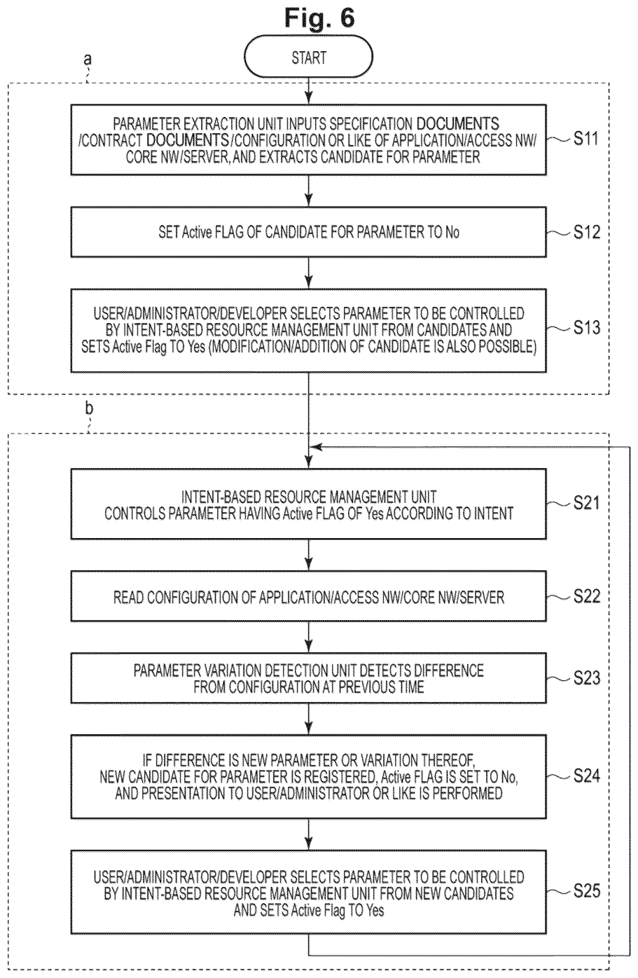

FIG. 6 is a flowchart illustrating an example of a procedure of processing by the data processing apparatus according to the one embodiment of the present invention.

First, as the first stage (reference sign a in FIG. 6), each parameter extraction unit extracts candidates for a type and a range of a value of a parameter to be controlled, from each of the management files D1 to D4, that is, specification documents, contract documents, configurations, and the like of an application, an access network, a core network, and a server, and transfers the candidates together with information on an extraction source to each parameter collection unit (S11).

Each parameter collection unit sets an initial value of the Active flag associated with the candidate for the parameter extracted in S11 to “No” (312).

The user, the administrator, the developer, or the like selects a parameter to be controlled by the intent-based resource management unit 51 from the candidates extracted in S11, and performs an input operation to the resource management apparatus 100 to designate the parameter as the candidate for the parameter to be controlled. The designation unit 52 receives this input operation and sets the Active flag related to the parameter designated by the input operation to “Yes”, Each parameter collection unit transfers the type of the parameter, the range of the value of the parameter, the extraction source, and the Active flag to the intent-based resource management unit 51 in association with each other (S13).

Then, as the second stage (reference sign b in FIG. 6), the intent-based resource management unit 51 controls the parameter associated with the Active flag set to “Yes”, according to an intent (S21).

In addition, each parameter variation detection unit reads each of the management files D1 to D4, that is, configurations of the application, the access network, the core network, the server, and the like (S22), and detects a difference between the current content and the content at a time before a predetermined time from the current time point (S23).

If the difference detected in S23 is a new parameter that has not existed until the previous time point or a variation thereof, each parameter variation detection unit registers this parameter as a new parameter to be controlled, and sets the initial value of the Active flag related to this parameter to “No”. Each parameter variation detection unit presents information regarding this parameter to the user, the administrator, the developer, or the like (S24).

The user, the administrator/developer, or the like performs an input operation to the resource management apparatus 100 to select (designate) a parameter to be controlled by the intent-based resource management unit 51 from the presented candidates. The designation unit 52 receives the input operation and sets the Active flag associated with the selected parameter to “Yes” in response to the input operation (S25).

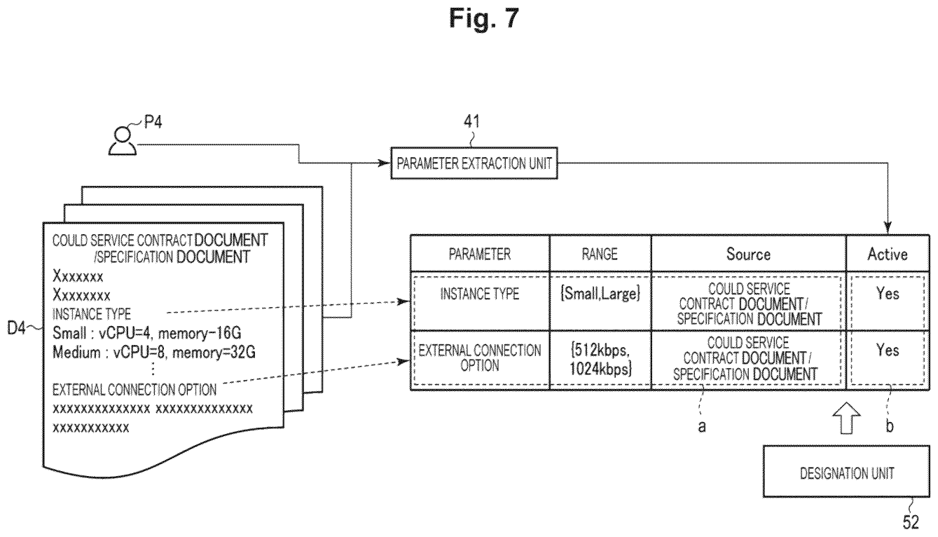

FIG. 7 is a diagram illustrating a specific example of parameter extraction.

Here, an example in which candidates for the parameter are extracted by the parameter extraction unit 41 from the cloud service contract document/specification document in the management file D4 in the first stage will be described.

In the example illustrated in FIG. 7, as a first parameter, “instance type” described in the cloud service contract document/specification document is extracted as the candidate for the type of the parameter to be controlled, “Small” and “Large” described in the cloud service contract document/specification document are extracted as the range of the value of the parameter to be controlled, and the cloud service contract document/specification document are extracted as the candidate extraction sources of the parameter to be controlled, respectively, and the Active flag is set to “Yes” by the cloud administrator/developer (reference sign P4 in FIG. 7).

Furthermore, in the example illustrated in FIG. 7, as a second parameter, “external connection option” described in the cloud service contract document/specification document is extracted as the candidate for s the type of parameter to be controlled, “512 kbps” and “1024 kbps” described in the cloud service contract document/specification document are extracted as the range of the value of the parameter to be controlled, and the cloud service contract document/specification document are extracted as the candidate extraction sources of the parameter to be controlled, respectively, and the Active flag is set to “Yes” by the cloud administrator/developer (reference sign P4 in FIG. 7).

An item surrounded by the reference sign a in FIG. 7 is an item set through automatic extraction by the parameter extraction unit 41. An item surrounded by the reference sign b in FIG. 7 is an item set by the designation unit 52 in response to an input operation by the cloud administrator or the like.

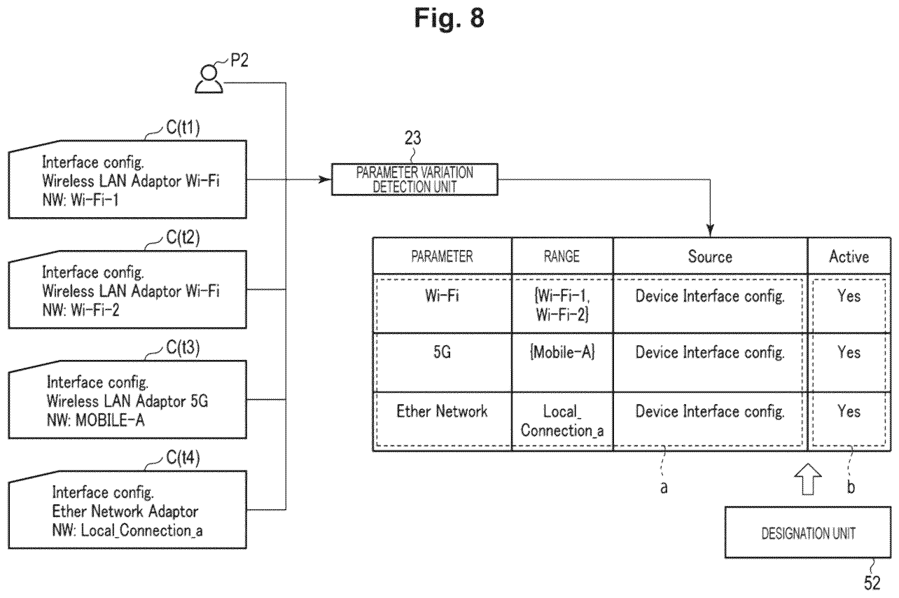

FIG. 8 is a diagram illustrating a specific example of parameter variation detection.

Here, an example in which, in the second stage, parameter variation is detected by the parameter variation detection unit 23 from the configuration of the access network in the management file D2, and a new candidate for the type of the parameter or the range of the value of the parameter according to the variation is extracted will be described.

In the example illustrated in FIG. 8, the parameter variation detection unit 23 performs comparison of the contents described in the configuration of the access network of the device (c(t1) to c(t4) in FIG. 8) between a time before the time t1 and a time section of the times t1 to t4 after the time t1 to detect the variation in the type of the parameter and the variation in the value of the parameter described in the management file at different timings.

The parameter variation detection unit 23 can detect a difference in that a new parameter. “Wi-Fi” and the value (ID) “Wi-Fi-1” which have not been described in the configuration at the time before the time t1 are described in the configuration at the time t1.

The parameter variation detection unit 23 can detect a difference in that a new parameter “Wi-Fi” and the value “Wi-Fi-2” which have not been described in the configuration at the time before the time t1 are described in the configuration at the time t2 after the time t1.

The parameter variation detection unit 23 can detect a difference in that a new parameter “SG” (5th Generation) and the value “Mobile-A” which have not been described in the configuration at the time before the time t1 are described in the configuration at a time t3 after the time t2.

The parameter variation detection unit 23 can detect a difference in that a new parameter “Ether Network” and the value “Local_Connection_a” which have not been described in the configuration at the time before the time t1 are described in the configuration at a time t4 after the time t3.

As a result of the above detection, it is detected that the new parameters are “Wi-Fi”, “5G”, and “Ether Network” in the time before the time t1 and the time section of the above times t1 to t4 after the time t1. The range of the possible value for the parameter “Wi-Fi” is “Wi-Fi-1” or “Wi-Fi-2”. The possible value for the new parameter “5G” is “Mobile-A”, and the possible value for the new parameter “Ether Network” is “Local_Connection_a”.

These new parameters and the values thereof serve as candidates for new parameters to be controlled by the intent-based resource management unit 51.

In addition, since the user or the administrator/developer (reference sign P2 in FIG. 8) performs an input operation for selecting (designating) a parameter to be actually controlled by the intent-based resource management unit 51 among the new candidates for the parameter to the resource management apparatus 100, the designation unit 52 sets the Active flag associated with the parameter selected by this input operation to “Yes”.

An item surrounded by the reference sign a in FIG. 8 is an item set through detection by the parameter variation detection unit 23. An item surrounded by the reference sign b in FIG. 8 is an item set by the designation unit 52 in response to an input operation by the access network administrator or the like.

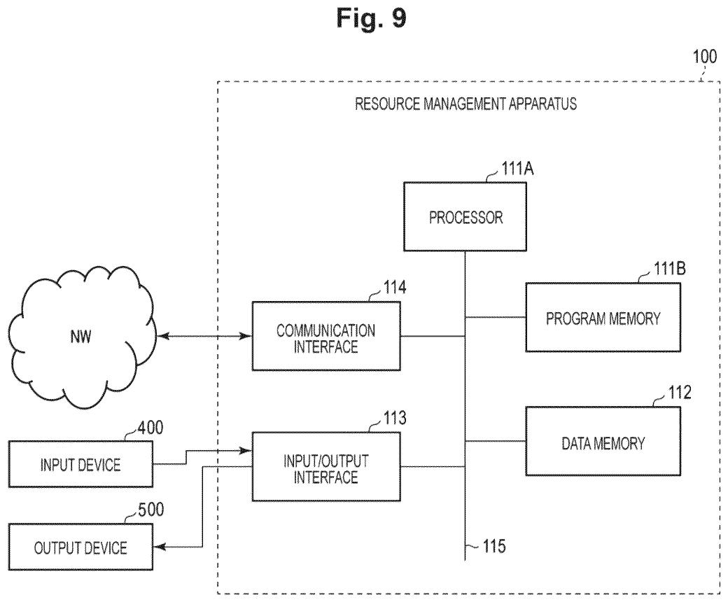

FIG. 9 is a block diagram illustrating an example of a hardware configuration of the resource management apparatus according to the one embodiment of the present invention.

In the example of FIG. 9, the resource management apparatus 100 according to the above-described embodiment includes, for example, a server computer or a personal computer, and includes a hardware processor 111A such as a central processing unit (CPU). In addition, a program memory 111B, a data memory 112, an input/output interface 113, and a communication interface 114 are connected to the hardware processor 111A via a bus 115.

The communication interface 114 includes, for example, one or more wireless communication interface units, and enables transmission and reception of information to/from a communication network NW. As a wireless interface, for example, an interface is used in which a low-power wireless data communication standard such as a wireless local area network (LAN) is adopted.

An input device 400 and an output device 500 that are attached to the resource management apparatus 100 and that are used by a user or the like are connected to the input/output interface 113.

The input/output interface 113 can perform processing of fetching operation data inputted by a user or the like via the input device 400 such as a keyboard, a touch panel, a touchpad, or a mouse, and outputting output data to the output device 500 including a display device using liquid crystal, organic electro luminescence (EL), or the like to display the output data. Note that, as the input device 400 and the output device 500, a device built in the resource management apparatus 100 may be used, and an input device and an output device of another information terminal that can communicate with the resource management apparatus 100 via the network NW may be used.

The program memory 111B is used as a non-transitory tangible storage medium, for example, as a combination of a non-volatile memory on which writing and reading can be performed as necessary, such as a hard disk drive (HDD) or a solid state drive (SSD), and a non-volatile memory such as a read only memory (ROM), and stores programs necessary for executing various kinds of control processing according to the one embodiment.

The data memory 112 is used as a tangible storage medium, for example, as a combination of the above-described non-volatile memory and a volatile memory such as a random access memory (RAM), and is used to store various kinds of data acquired and created in a process in which various types of processing are performed.

The resource management apparatus 100 according to the one embodiment of the present invention can be configured as a data processing apparatus including each parameter extraction unit, each parameter collection unit, and each parameter variation detection unit illustrated in FIG. 1 as processing function units by software.

Each information storage unit used as a working memory or the like by each unit of the resource management apparatus 100 can be configured by using the data memory 112 illustrated in FIG. 9. However, these formed storage areas are not essential configurations in the resource management apparatus 100, and may be areas provided in, for example, an external storage medium such as a universal serial bus (USB) memory or a storage device such as a database server arranged in a cloud.

All of the processing function units of each parameter extraction unit, each parameter collection unit, and each parameter variation detection unit can be implemented by causing the hardware processor 111A to read and execute the program stored in the program memory 1118. Note that some or all of these processing function units may be implemented in other various forms including an integrated circuit such as an application specific integrated circuit (ASIC) or a field-programmable gate array (FPGA).

In addition, the methods described in each embodiment can be stored in a recording medium such as a magnetic disk (for example, Floppy (registered trademark) disk or hard disk), an optical disc (for example, CD-ROM, DVD, or MO), or a semiconductor memory (for example, ROM, RAM, or flash memory) as a program (software means) which can be executed by a computing machine (computer) and can be distributed by being transmitted through a communication medium. Note that the programs stored in the medium also include a setting program for configuring, in the computing machine, software means (including not only an execution program but also a table and a data structure) to be executed by the computing machine. The computing machine that implements the present device executes the above processing by reading the programs recorded in the recording medium, constructing the software means by the setting program as needed, and controlling operation by the software means. Note that the recording medium in the present specification is not limited to a recording medium for distribution, and includes a storage medium such as a magnetic disk or a semiconductor memory provided inside the computing machine or in a device connected via a network.

The present invention is not limited to the above embodiment, and various types of modifications can be made at an implementation stage without departing from the gist of the invention. The respective embodiment may be implemented in appropriate combination, and in that case, a combined effect can be achieved. The above embodiment includes various types of inventions, and various types of inventions can be extracted according to a combination selected from a plurality of disclosed components. For example, even if some components are eliminated from all the components described in the embodiment, a configuration from which the components are eliminated can be extracted as an invention in a case where the problem can be solved and the advantageous effects can be achieved.

### REFERENCE SIGNS LIST

100 Resource management apparatus
11, 21, 31, 41 Parameter extraction unit
12 Application parameter collection unit
13, 23, 33, 43 Parameter variation detection unit
22 Access network parameter collection unit
32 Core network parameter collection unit
42 Cloud parameter collection unit
51 Intent-based resource management unit
52 Designation unit

1. A data processing apparatus comprising:
an extraction unit that extracts a candidate for a resource used to provide a service and a candidate for a parameter used to control the resource, from a file in which a content of provision of the service is described; and
a designation unit that receives a designation of a resource and a parameter to be used to provide the service among resources and parameters extracted by the extraction unit.

2. The data processing apparatus according to claim 1, wherein
the extraction unit
further extracts, when there is a difference between a content described in the file at a first timing and a content described in the file at a second timing after the first timing, candidates that have not been extracted from the file at the first timing, the candidates being a candidate for a new resource used to provide the service and a candidate for a new parameter used to control the resource.

3. The data processing apparatus according to claim 1, wherein
the extraction unit
extracts, from the file, a candidate for a type of the parameter used to provide the service and a candidate for a possible value for the parameter of the type.

4. The data processing apparatus according to claim 2, wherein
the extraction unit
further extracts a candidate for a type of the new parameter and a candidate for a possible value for the parameter of the type.

5. A data processing method performed by a data processing apparatus, the method comprising:
extracting, by an extraction unit of the data processing apparatus, a candidate for a resource used to provide a service and a candidate for a parameter used to control the resource from a file in which a content of provision of the service is described; and
receiving, by a designation unit of the data processing apparatus, a designation of a resource and a parameter to be used to provide the service among extracted resources and parameters.

6. A non-transitory computer-readable medium having computer-executable instructions that, upon execution of the instructions by a processor of a computer, cause the computer to function as each of the units of the data processing apparatus according to claim 1.
